(19) United States
(12) Patent Application Publication
(10) Pub. No.: US 2006/0249036 A1
(43) Pub. Date: Nov. 9, 2006

(54) Barbecue grill with a smoker

(76) Inventor: George C.M. Liu, Dou-Liou City (TW)

Correspondence Address: HERSHKOVITZ & ASSOCIATES, 2845 DUKE STREET, ALEXANDRIA, VA, 22314, US

(21) Appl. No.: 11/123,088

(22) Filed: May 6, 2005

(51) Int. Cl. A23N 1/00

(52) U.S. Cl. 99/511

(57) ABSTRACT

A barbecue grill with a smoker, the smoker has a housing having a bottom and pivotally connected to a side of the barbecue grill and a heater at the bottom of the housing. The heater allows to cook or smoke their food so multiple tastes can be prepared during a barbecue.

### BACKGROUND OF THE INVENTION

1. Field of the Invention

The present invention relates to a barbecue grill, and more particularly to a barbecue grill with a smoker that is able to smoke food.

2. Description of Related Art

Outdoor roasting is a very popular activity with most people. A basic requirement of outdoor roasting is a conventional barbecue grill. The barbecue grill is able to roast and cook food.

With reference to FIG. 5, a conventional barbecue grill (40) comprises a grill body (41), a lid (42), a control panel (not numbered) and an optional cutting board (not shown).

The grill body (41) has a top (not numbered), a bottom (not numbered), a front (not numbered), two sides (not numbered), a fuel tank (not shown), a burner (not shown) and multiple wheels (not numbered). The fuel tank is mounted inside the grill body (41) and may be gas or liquid fuel. The burner is mounted on the top of the grill body (41) and provides heat to roast or grill food so that the food only can be roasted or grilled. The wheels are mounted rotatably on the bottom of the grill body (41). The control panel is mounted on the front of the grill body (41) and controls the burner and fuel. The lid (42) is pivotally mounted on the top of the grill body (41) and selectively covers the burner. The cutting board is mounted on top of the grill body (41) or one side of the grill body (41).

Since the barbecue grill (40) can only roast or grill food, people who prefer another taste rather than roasted or grilled food must use a cooking apparatus other than a conventional barbecue grill (40).

To overcome the shortcomings, the present invention provides a barbecue grill with a smoker to obviate or mitigate the aforementioned problems.

### SUMMARY OF THE INVENTION

The primary objective of the present invention is to provide a barbecue grill with a smoker that allows people to grill, cook and smoke their food when they have a barbecue.

The smoker has a housing having a bottom and pivotally connected to a side of the barbecue grill and a heater at the bottom of the housing. The heater allows people to cook or smoke their food so multiple tastes can be prepared during a barbecue.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a barbecue grill with a smoker in accordance with the present invention;

FIG. 2 is a perspective view of the barbecue grill in FIG. 1 when the housing does not cover the heater;

FIG. 3 is a perspective view of the barbecue grill in FIG. 1 when a pot is placed on the heater;

FIG. 4 is a perspective view of a second embodiment of a barbecue grill with a smoker in accordance with the present invention; and

FIG. 5 is a perspective view of a conventional barbecue grill in accordance with the prior art.

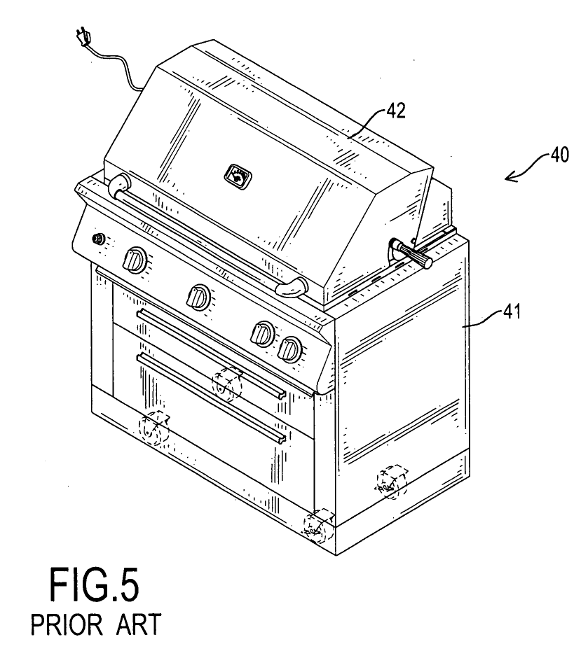

### DETAILED DESCRIPTION OF THE PREFERRED EMBODIMENT

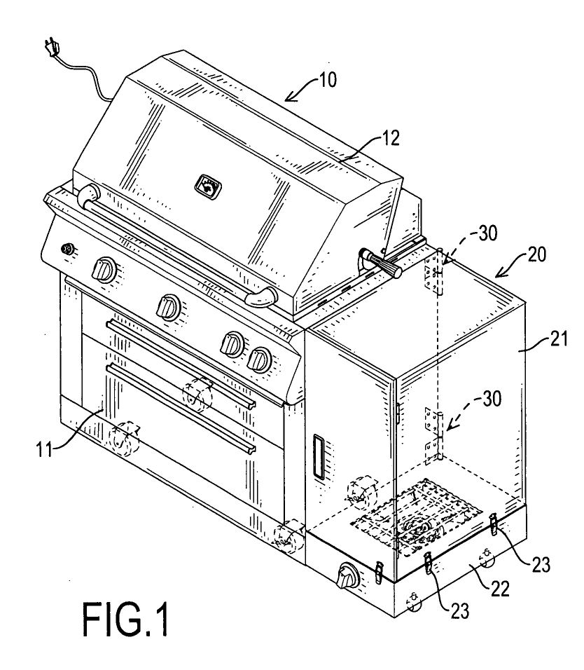

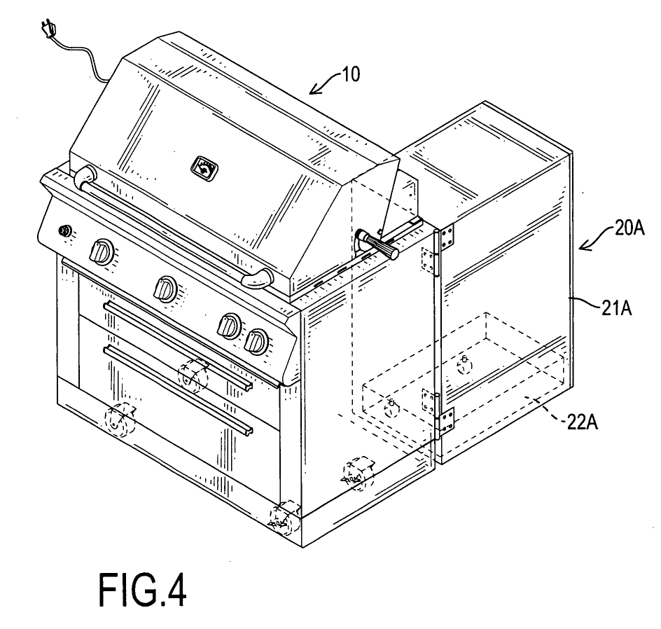

With reference to FIGS. 1 and 4, a barbecue grill (10) with a smoker (20, 20A) in accordance with the present invention has a grill body (11) with a top and a bottom, a lid (12) pivotally mounted on the top of the grill body (11), multiple wheels rotatably mounted on the bottom of the grill body (11) and a side with an edge. The smoker (20, 20A) is securely attached at the side of the barbecue grill (10) and has multiple hinges (30), a heater (22, 22A), a housing (21, 21A) and optional buckles (23).

In a first embodiment of the smoker (20) in accordance with the present invention for a barbecue grill (10), the heater (22) is securely attached to the side of the barbecue grill (10) and has a bottom and multiple optional wheels rotatably mounted on the bottom of the heater (22).

The housing (21) is pivotally connected to an edge of the side of the barbecue grill (10) with the hinges (30) and has a front, a bottom, multiple edges, an optional opening and an optional door. The bottom selectively aligns with the heater (22). The opening is formed through the front of the housing (21). The door is connected pivotally to the front of the housing (21) to close the opening in the housing (21).

The buckles (23) are mounted on edges of the housing (21) and the heater (22) to lock the housing (21) to the heater (22) when the bottom of the housing (21) aligns with the heater (22).

In a second embodiment of the smoker (20A) in accordance with the present invention for a barbecue grill (10), the housing (21A) is connected pivotally to an edge of the side of the barbecue grill 10) with the hinges (30) and has an outer bottom, an inner bottom, a front, multiple optional wheels, an optional opening and an optional door. The wheels are mounted rotatably on the outer bottom of the housing (21A). The opening is formed through the front of the housing (21A). The door is connected pivotally to the front of the housing (21A) to close the opening in the housing (21A).

The heater (22A) is securely attached to the inner bottom of the housing (21A).

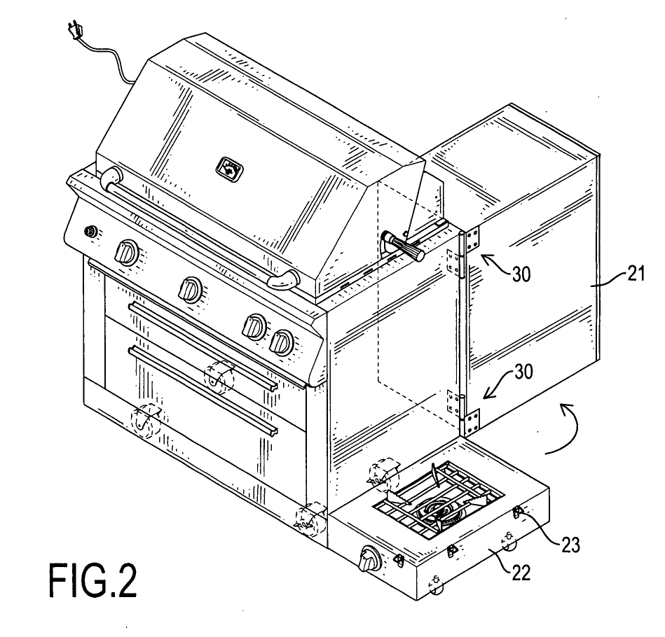

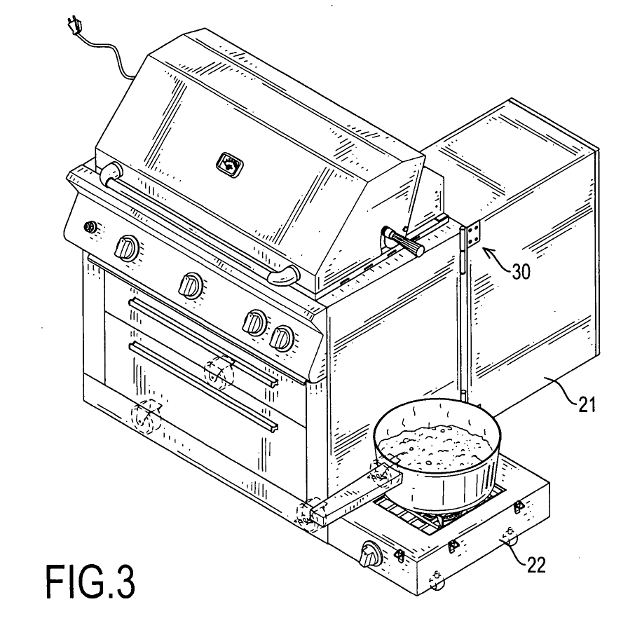

With reference to FIGS. 1, 2 and 3, the heater (22) of the smoker (20) is able to cook food when a pot, a pan or a steamer is placed on the heater (22). Furthermore, when the housing (21) covers the heater (22) and the food is placed on the heater (22), the food can be smoked. The buckles (23) can lock the housing (21) to the heater (22) to prevent heat from the heater (22) from escaping from the housing (21). When people use the barbecue grill (10) and smoker (20) at same time, people are able to have multiple tastes of food.

In conclusion, the smoker (22, 22A) and the barbecue grill (10) both are able to provide multiple ways to cook food such as smoking, boiling, grilling, roasting and the like. People are able to have multiple tastes of food when they use the smoker (22, 22A) and the barbecue grill (10) during a barbecue.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

1. A barbecue grill with a smoker, the barbecue grill having a body, a lid pivotally mounted on top of the grill body and a side, wherein
the smoker is securely attached to the side of the barbecue grill and has a housing having
multiple hinges and being pivotally connected to an edge of the side of the barbecue grill and having a bottom; and
a heater mounted at the bottom of the housing and securely attached to the side of the barbecue grill.

2-4. (canceled)

5. The barbecue grill as claimed in claim 1, wherein the smoker further has buckles mounted on edges of the housing and the heater to lock the housing and the heater when the housing covers the heater.

6. (canceled)

7. The barbecue grill as claimed in claim 1, wherein the heater is securely attached to an inner bottom of the housing.

8-12. (canceled)

13. The barbecue grill as claimed in claim 7, wherein the barbecue grill and the heater further have multiple wheels rotatably mounted on bottoms of the grill body and the heater.

14. (canceled)

15. The barbecue grill as claimed in claim 7, wherein the barbecue grill and the housing further have multiple wheels rotatably mounted on bottoms of the grill body and the housing.

16. (canceled)
